(19) United States
(12) Patent Application Publication
(10) Pub. No.: US 2019/0251448 A1
(43) Pub. Date: Aug. 15, 2019

(54) INTEGRATED CIRCUIT CHIP DEVICE AND RELATED PRODUCT THEREOF

(71) Applicant: Shanghai Cambricon Information Technology Co., Ltd, Shanghai (CN)

(72) Inventors: Yukun TIAN, Shanghai (CN); Zhou FANG, Shanghai (CN); Zidong DU, Shanghai (CN)

(21) Appl. No.: 16/273,031

(22) Filed: Feb. 11, 2019

Related U.S. Application Data
(63) Continuation-in-part of application No. 16/272,963, filed on Feb. 11, 2019.

(30) Foreign Application Priority Data
Feb. 11, 2018 (CN) 201810141373.9

(51) Int. Cl. G06N 3/08; G06F 9/30

(52) U.S. Cl. CPC G06N 3/084; G06F 9/3004

(57) ABSTRACT

The present disclosure provides an integrated circuit chip device and related product thereof. The integrated circuit chip device includes an external interface and a processing circuit. The processing circuit is configured to quantize the first layer input data and the first layer weight group data to obtain a first layer quantized input data and a first layer quantized weight group data; query a first layer output data corresponding to the first layer quantized input data and the first layer quantized weight group data from a preset output result table, determine the first layer output data as a second layer input data, and input the second layer input data into n-1 layers to execute forward operations to obtain nth layer output data; the n^{th} layer output data gradients is determined according to the n^{th} layer output data and the n^{th} layer back operations is obtained according to the training instructions.

### CROSS-REFERENCE TO RELATED APPLICATIONS

The present invention is a continuation-in-part of U.S. application Ser. No. 16/272,963, filed on Feb. 11, 2019, which claims priority to CN Application No. 201810141373.9, filed on Feb. 11, 2018. The entire contents of each of the aforementioned applications are incorporated herein by reference.

### BACKGROUND

An existing training method for neural networks generally adopts backpropagation algorithm, and a learning process consists of a forward propagation process and a backpropagation process. In the forward propagation process, input data passes through an input layer and hidden layers, and then the data is processed layer by layer and transmitted to an output layer. If expected output data may not be obtained in the output layer, a back propagation process can be performed, and, in the backpropagation process, weight gradients of each layer are computed layer by layer; finally, the computed weight gradients are configured to update weight. This is an iteration of neural network training. Those processes need to be repeated a plurality of times in the whole training process until the output data reaches an expected value. In the training process, the training method has problems including an excessive amount of parameters and operations as well as low training efficiency.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example integrated circuit chip device for training a multi-layer neural network that includes n layers and n being an integer greater than 1. The integrated circuit chip device may include an external interface configured to receive one or more training instructions. Further, the integrated circuit chip device may include a processing circuit configured to determine a first layer input data and a first layer weight group data, quantize the first layer input data and the first layer weight group data to obtain a first layer quantized input data and a first layer quantized weight group data, query a first layer output data corresponding to the first layer quantized input data and the first layer quantized weight group data from a preset output result table, determine the first layer output data as a second layer input data, and input the second layer input data into n-1 layers to execute forward operations to obtain n^{th} layer output data, determine n^{th} layer output data gradients of the n^{th} layer output data, obtain n^{th} layer back operations among the back operations of n layers of the training instructions, quantize the n^{th} layer output data gradients to obtain n^{th} layer quantized output data gradients, query n^{th} layer input data gradients corresponding to the nth layer quantized output data gradients and a n^{th} layer quantized input data from the preset output result table, query n^{th} layer weight group gradients corresponding to the n^{th} layer quantized output data gradients and a n^{th} layer quantized weight group data from the preset output result table, update a weight group data of n layers of the n^{th} layer weight group gradients, determine the n^{th} input data gradients as (n-1)^{th} output data gradients, input the n^{th} input data gradients into n-1 layers to execute back operations to obtain n-1 weight group data gradients, and update n-1 weight group data corresponding to the n-1 weight group data gradients of the n-1 weight group data gradients, wherein the weight group data of each layer comprises at least two weights.

Another example aspect of the present disclosure provides an example method for executing neural network training. The example method may include receiving training instructions; determining a first layer input data and a first layer weight group data; quantizing the first layer input data and the first layer weight group data to obtain the first layer quantized input data and the first layer quantized weight group data; querying a first layer output data corresponding to the first layer quantized input data and the first layer quantized weight group data from the preset output result table, determining the first layer output data as the second layer input data and inputting the second layer input data into n-1 layers to execute forward operations to obtain the n^{th} layer output data; determining n^{th} layer output data gradients of the n^{th} layer output data, obtaining the n^{th} layer back operations among back operations of n layers of the training instructions, quantizing the n^{th} layer output data gradients to obtain n^{th} layer quantized output data gradients; querying n^{th} layer input data gradients corresponding to the n^{th} layer quantized output data gradients and a n^{th} layer quantized input data from the preset output result table, querying n^{th} layer weight group gradients corresponding to the n^{th} layer quantized output data gradients and a n^{th} layer quantized weight group data from the preset output result table, and updating the weight group data of n layers of the n^{th} layer weight group gradients; determining the n^{th} input data gradients as the (n-1)^{th} output data gradients, inputting the (n-1)^{th} output data gradients into n-1 layers to execute back operations to obtain the n-1 weight group data gradients, updating the n-1 weight group data corresponding to the n-1 weight group data gradients of the n-1 weight group data gradients, wherein the weight group data of each layer comprises at least two weights.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a structural diagram of an integrated circuit chip device according to an embodiment of the present disclosure.

FIG. 2a is a flow chart of a neural network training method according to an embodiment of the present disclosure.

FIG. 2b is a schematic diagram of a weight grouping according to an embodiment of the present disclosure.

FIG. 2c is a schematic diagram of a clustering weight groups according to an embodiment of the present disclosure.

FIG. 2d is a schematic diagram of an intermediate codebook according to an embodiment of the present disclosure.

FIG. 2e is a schematic diagram of weight group data according to an embodiment of the present disclosure.

FIG. 2f is a schematic diagram of a weight dictionary according to an embodiment of the present disclosure.

FIG. 2g is a schematic diagram of a quantized weight group data according to an embodiment of the present disclosure.

FIG. 3 is a structural diagram of another integrated circuit chip device according to an embodiment of the present disclosure.

FIG. 4 is a structural diagram of a neural network chip device according to an embodiment of the present disclosure.

FIG. 5a is a structural diagram of a combined processing device according to an embodiment of the present disclosure.

FIG. 5b is another structural diagram of a combined processing device according to an embodiment of the present disclosure.

### DETAILED DESCRIPTION

Various aspects are now described with reference to the drawings. In the following description, for purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding of the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for a clear and concise purpose, some known functionality and structure are not described. Besides, identical reference numbers refer to identical function and operation throughout the accompanying drawings.

To facilitate those skilled in the art to understand the present disclosure, technical solutions in the embodiments of the present disclosure will be described clearly and completely hereinafter with reference to the accompanying drawings in the embodiments of the present disclosure. Apparently, the described embodiments are merely some rather than all embodiments of the present disclosure. All other embodiments obtained by those of ordinary skill in the art based on the embodiments of the present disclosure without creative efforts shall fall within the protection scope of the present disclosure.

The terms such as “first”, “second” and the like configured in the specification, the claims, and the accompanying drawings of the present disclosure are configured for distinguishing between different objects rather than describing a particular order. The terms “include” and “comprise” as well as variations thereof are intended to cover a non-exclusive inclusion. For example, a process, method, system, product, device, or apparatus including a series of steps or units is not limited to the listed steps or units, it may alternatively include other steps or units that are not listed; alternatively, other steps or units inherent to the process, method, product, or device may be included either.

The term “embodiment” or “implementation” referred to herein means that a particular feature, structure, or characteristic described in conjunction with the embodiment may be contained in at least one embodiment of the present disclosure. The phrase appearing in various places in the specification does not necessarily refer to the same embodiment, nor does it refer to an independent or alternative embodiment that is mutually exclusive with other embodiments. It is expressly and implicitly understood by those skilled in the art that an embodiment described herein may be combined with other embodiments.

In the device provided in the first aspect, for quantizing the first layer weight group data, the processing circuit 104 includes: a control unit, configured to obtain quantization instructions and decode the quantization instructions to obtain query control information, the query control information including address information corresponding to the first layer weight group data in a preset weight dictionary, the preset weight dictionary including encodings corresponding to all the weights in weight group data of n layers of the neural network; a dictionary query unit, configured to query K encodings corresponding to K weights in the first layer weight group data from the preset weight dictionary according to the query control information, K being an integer greater than 1; a codebook query unit, configured to query K quantized weights in the first layer quantized weight group data from the preset codebook according to the K encodings, the preset codebook including Q encodings and Q central weights corresponding to the Q encodings, and Q is an integer greater than 1.

In the device provided in the first aspect, the device further includes a weight dictionary establishment unit, configured to: determine closest central weights of each weight in weight group data of the n layers of the neural network to the Q central weights in the preset codebook, prior to quantizing the first layer weight group data, and obtain the central weights corresponding to each weight in the weight group data of the n layers; determine encodings of the central weights corresponding to each weight in the weight group data of the n layers according to the preset codebook, obtain the encoding corresponding to each weight in the weight group data of the n layers of the neural network and generate a weight dictionary.

In the device provided in the first aspect, the preset codebook is obtained according to the following steps: grouping a plurality of weights to obtain a plurality of groups; clustering weights in each group in the plurality of groups according to a clustering algorithm to obtain a plurality of clusters; computing a central weight of each cluster in the plurality of clusters; encoding the central weight of each cluster in the plurality of clusters and generating the codebook.

In the device provided in the first aspect, the clustering algorithm includes any of the following algorithms: K-means algorithm, K-medoids algorithm, Clara algorithm, and Clarans algorithm.

In the device provided in the first aspect, the neural network includes a convolution layers, b full connection layers, and c long short-term memory network layers. Herein, a refers to a count of convolution layers; b refers to a count of full connection layers; and c refers to a count of long short-term memory network layers. The step of grouping a plurality of weights to obtain a plurality of groups includes: grouping weights in each convolution layer of the plurality of weights into a group, weights in each full connection layer of the plurality of weights into a group and weights in each long short-term memory network layer of the plurality of weights into a group to obtain (a+b+c) groups; the step of clustering weights in each group in the plurality of groups according to a clustering algorithm includes: clustering weights in each of the (a+b+c) groups according to the K-medoids algorithm.

In the device provided in the first aspect, for quantizing the first layer input data, the processing circuit 104 includes: a preprocessing unit, configured to preprocess any element value in the first layer input data by using a clip (−zone, zone) operation to obtain the first layer preprocessing data in the preset section [−zone, zone], zone being greater than 0; a determination unit, configured to determine M values in the preset section [−zone, zone], M being a positive integer, compute absolute values of differences between the first layer preprocessing data and the M values respectively to obtain M absolute values, and determine a minimum absolute value of the M absolute values as the quantized element value corresponding to the element value.

In the method provided in the second aspect, the quantizing the first layer weight group data includes: obtaining quantization instructions and decoding the quantization instructions to obtain query control information, the query control information including address information corresponding to the first layer weight group data in a preset weight dictionary, the preset weight dictionary including encodings corresponding to all the weights in weight group data of the n layers of the neural network; querying K encodings corresponding to K weights in the first layer weight group data from the preset weight dictionary according to the query control information; K is an integer greater than 1; querying K quantized weights in the first layer quantized weight group data from the preset codebook according to the K encodings, the preset codebook including Q encodings and Q central weights corresponding to the Q encodings, and Q is an integer greater than 1.

In the method provided in the second aspect, the preset weight dictionary is obtained according to the following steps: determining the closest central weights of each weight in weight group data of n layers of the neural network to the Q central weights in the preset codebook, prior to quantizing the first layer weight group data, and obtaining the central weights corresponding to each weight in the weight group data of the n layers; determining encodings of the central weights corresponding to each weight in the weight group data of the n layers according to the preset codebook, obtaining the encoding corresponding to each weight in the weight group data of the n layers of the neural network and generating a weight dictionary.

In the method provided in the second aspect, the preset codebook is obtained according to the following steps: grouping a plurality of weights to obtain a plurality of groups; clustering weights in each group in the plurality of groups according to a clustering algorithm to obtain a plurality of clusters; computing a central weight of each cluster in the plurality of clusters; encoding the central weight of each cluster in the plurality of clusters and generating the codebook.

In the method provided in the second aspect, the quantizing the first layer input data includes: preprocessing any element value in the first layer input data by using clip (−zone, zone) operation to obtain the first layer preprocessing data in the preset section [−zone, zone], wherein zone is greater than 0.

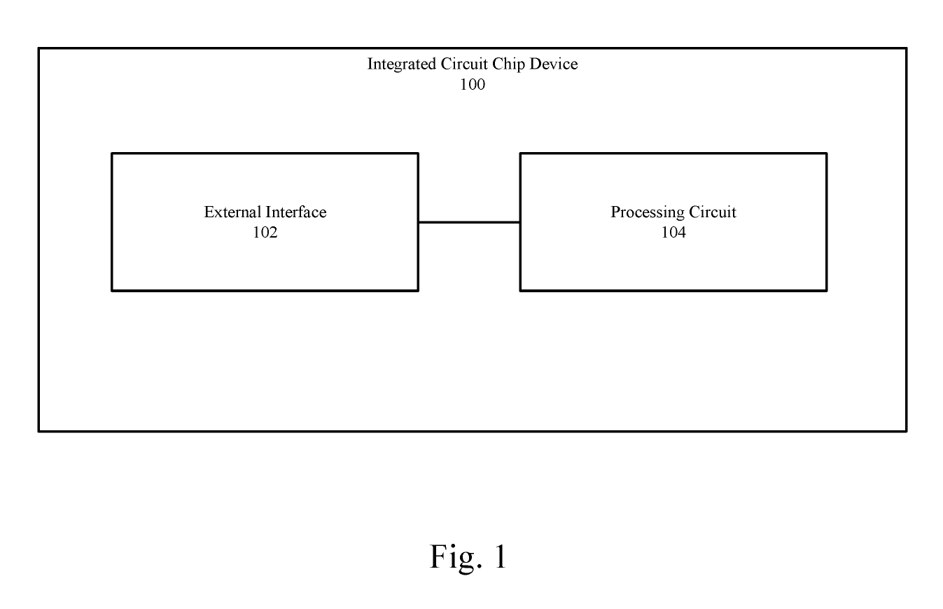

FIG. 1 is a structure diagram of an integrated circuit chip device 100 according to an embodiment of the present disclosure. The integrated circuit chip device 100 may be configured to train the neural network and the neural network includes n layers, n being an integer greater than 1. The integrated circuit chip device 100 may include an external interface 102 and a processing circuit 104. The external interface 102 may be configured to receive training instructions. The processing circuit 104 may be configured to determine the first layer input data, the first layer weight group data and the operation instructions included in the first layer according to the training instructions, quantize the first layer input data and the first layer weight group data to obtain the first layer quantized input data and the first layer quantized weight group data; query the first layer output data corresponding to the first layer quantized input data and the first layer quantized weight group data from the preset output result table, determine the first layer output data as the second layer input data, and input the second input data into the n-1 layers to execute forward operations to obtain the nth layer output data.

The processing circuit 104 may be further configured to determine the n^{th} layer output data gradients according to the n^{th} layer output data, obtain the n^{th} layer back operations among the back operations of the n layers according to the training instructions, quantize the n^{th} layer output data gradients to obtain the n^{th} layer quantized output data gradients, query the n^{th} layer input data gradients corresponding to the n^{th} layer quantized output data gradients and the n^{th} layer quantized input data from the preset output result table, query the n^{th} layer weight group gradients corresponding to the n^{th} layer quantized output data gradients and the n^{th} layer quantized weight group data from the preset output result table, and update the weight group data of n layers according to the n^{th} layer weight group gradients.

The processing circuit 104 may be further configured to determine the n^{th} input data gradients as the n-1th output data gradients, and input the (n-1)^{th} output data gradients into the n-1 layers to execute back operations to obtain the n-1 weight group data gradients and update the n-1 weight group data corresponding to the n-1 weight group data gradients according to the n-1 weight group data gradients, wherein the weight group data of each layer includes at least two weights.

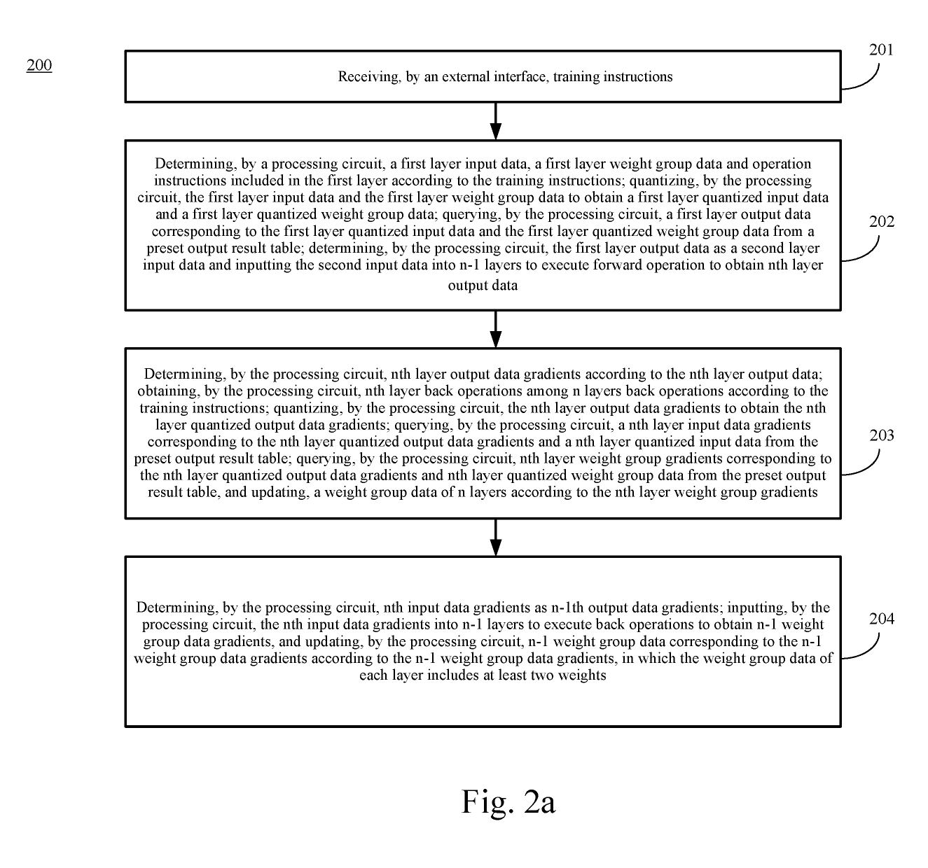

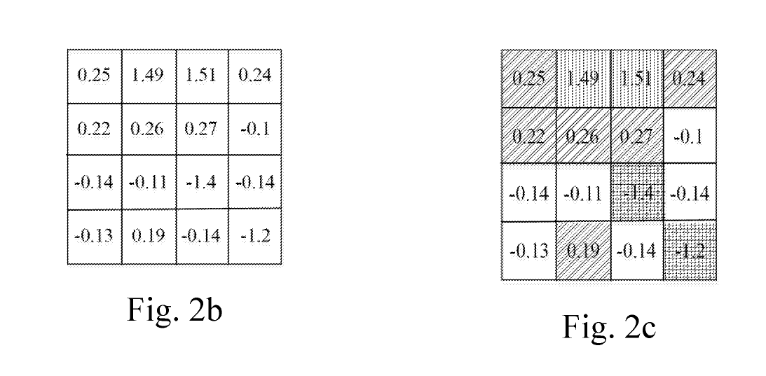

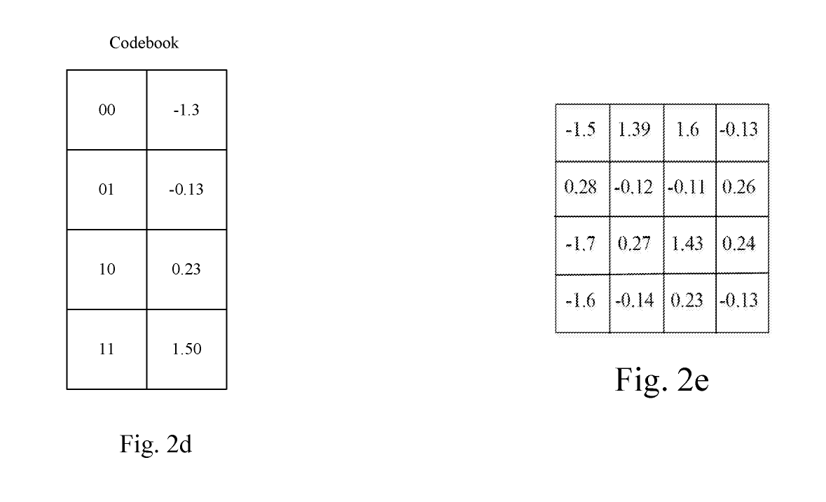

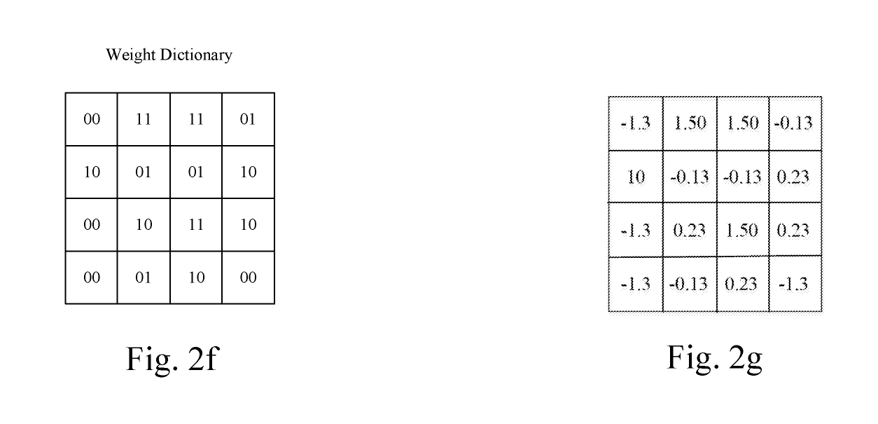

FIG. 2a is a flow chart of a neural network training method 200 according to an embodiment of the present disclosure. The neural network training method 200 described in the present embodiment may be implemented to train a neural network that includes n layers and n is an integer greater than 1. The neural network training method 200 may be performed by the components illustrated in FIGS. 1, 3, 5a and 5b.

At block 201, the external interface 102 receives training instructions. The training instructions are neural network specific instructions, including all specific instructions for completing artificial neural network operation. The neural network specific instructions may include but are not limited to control instructions, data transmission instructions, operation instructions, and logical instructions. The control instructions may be configured to control the execution process of the neural network. The data transmission instructions may be configured to complete data transmission between different storage media; data formats include but are not limited to matrices, vectors, and scalars. The operation instructions may be configured to complete arithmetic operations of neural network, including but not limited to matrix operation instructions, vector operation instructions, scalar operation instructions, convolution neural network operation instructions, fully connected neural network operation instructions, pooling neural network operation instructions, RBM neural network operation instructions, LRN neural network operation instructions, LCN neural network operation instructions and LSTM neural network operation instructions, RNN neural network operation instructions, RELU neural network operation instructions, PRELU neural network operation instructions, SIGMOID neural network operation instructions, TANH neural network operation instructions and MAXOUT neural network operation instructions. Logical instructions are configured to complete neural network logical operations, including but not limited to vector logical operation instructions and scalar logical operation instructions.

The RBM neural network operation instructions may be configured to implement Restricted Boltzmann Machine (RBM) neural network operations. The LRN neural network operation instructions may be configured to implement Local Response Normalization (LRN) neural network operation. The LSTM neural network operation instructions may be configured to implement Long Short-Term Memory (LSTM) neural network operation. The RNN neural network operation instructions may be configured to implement the neural network operation of Recurrent Neural Networks. The RELU neural network operation instructions are configured to implement Rectified Linear Unit (RELU, RNN) neural network operation. The PRELU neural network operation instructions are configured to implement Parametric Rectified Linear Unit (PRELU) neural network operations. The SIGMOID neural network operation instructions are configured to implement SIGMOID neural network operation. The TANH neural network operation instructions are configured to implement TANH neural network operation. The MAXOUT neural network operation instructions are configured to implement MAXOUT neural network operation. Furthermore, the neural network specific instructions include Cambricon instruction set.

The Cambricon instruction set includes at least one Cambricon instruction, and the length of the Cambricon instruction is 64 bits. The Cambricon instruction consists of operation codes and operands and contains four types of instructions, which are Cambricon control instructions, Cambricon data transfer instructions, Cambricon operation instructions and Cambricon logical instructions.

The Cambricon control instructions are configured to control the execution process and include jump instructions and conditional branch instructions.

The Cambricon data transfer instructions are configured to complete data transmission between different storage media and include load instructions, store instructions and move instructions. The load instructions are configured to load data from primary memory to cache, and the store instructions are configured to store data from cache to primary memory, and the move instructions are configured to move data between cache and cache or between cache and register or between register and register. The data transmission instructions support three different ways of data organization, including matrices, vectors, and scalars.

The Cambricon operation instructions are configured to complete arithmetic operation of the neural network and include Cambricon matrix operation instructions, Cambricon vector operation instructions and Cambricon scalar operation instructions.

The Cambricon matrix operation instructions are configured to complete matrix operations in the neural network, including matrix-multiply-vector operations, vector-multiply-matrix operations, matrix-multiply-scalar operations, outer product operations, matrix-add-matrix operations and matrix-subtract-matrix operations.

The Cambricon vector operation instructions are configured to complete vector operations in neural network, including vector elementary arithmetic operations, vector transcendental function operations, dot product operations, random vector generator operations and maximum/minimum of a vector operation, wherein the vector elementary arithmetic operations include vector addition operations, subtraction operations, multiplication operations, and division operations. The vector transcendental functions refer to the functions that do not satisfy any polynomial equation with polynomial coefficients, including but not limited to exponential functions, logarithmic functions, trigonometric functions, and inverse trigonometric functions.

The Cambricon scalar operation instructions are configured to complete scalar operations in neural networks, including scalar elementary arithmetic operations and scalar transcendental function operations, wherein the scalar elementary arithmetic operations include scalar addition subtraction operations, multiplication operations and division operations. The scalar transcendental functions refer to the functions that do not satisfy any polynomial equation with polynomial coefficients, including but not limited to exponential functions, logarithmic functions, trigonometric functions, and inverse trigonometric functions.

The Cambricon logical instructions are configured to complete logical operations of neural networks, including Cambricon vector logical operation instructions and Cambricon scalar logical operation instructions.

The Cambricon vector logical operation instructions include vector comparison operations, vector logical operations and vector greater than merge operations, wherein vector comparison operations include but are not limited to “greater than”, “less than”, “equal to”, “greater than or equal to”, “less than or equal to” and “not equal to”. The vector logical operations include “and”, “or” and “not”.

The Cambricon scalar logical operation instructions include scalar compare and scalar logical operations, wherein the scalar comparison operations include but are not limited to “greater than”, “less than”, “equal to”, “greater than or equal to”, “less than or equal to” and “not equal to”. The scalar logical operations include “and”, “or” and “not”.

At block 202, the processing circuit 104 may be configured to determine the first layer input data, the first layer weight group data and the operation instructions included in the first layer according to the training instructions, quantize the first layer input data and the first layer weight group data to obtain the first layer quantized input data and the first layer quantized weight group data; query the first layer output data corresponding to the first layer quantized input data and the first layer quantized weight group data from the preset output result table, and determine the first layer output data as the second layer input data, and input the second layer input data into the n-1 layers to execute forward operations to obtain the nth layer output data.

In an alternative embodiment, quantizing the first layer weight group data may include the following steps: obtaining quantization instructions and decoding the quantization instructions to obtain query control information, the query control information including address information corresponding to the first layer weight group data in a preset weight dictionary and the preset weight dictionary including encodings corresponding to all the weights in weight group data of n layers of the neural network; querying K encodings corresponding to K weights in the first layer weight group data from the preset weight dictionary according to the query control information, wherein K is an integer greater than 1; querying K quantized weights in the first layer quantized weight group data from the preset codebook according to the K encodings, the preset codebook including Q encodings and Q central weights corresponding to the Q encodings, and Q is an integer greater than 1.

In an alternative embodiment, the preset weight dictionary is obtained according to the following steps: determining the closest central weights of each weight in the weight group data of the n layers of the neural network to the Q central weights in the preset codebook, and obtaining the central weights corresponding to each weight in the weight group data of the n layers; determining encodings of the central weights corresponding to each weight in the weight group data of n layers according to the preset codebook, obtaining the encoding corresponding to each weight in the weight group data of n layers of the neural network and generating a weight dictionary.

The above central weights corresponding to each weight in the weight group data of n layers may be configured to replace values of all the weights in a cluster. Specifically, when establishing the preset codebook, all the weights of any cluster are computed according to the following cost function:

$$J ( w , {w}_{0} ) = {\sum }_{1}^{m} {( {w}_{i} - {w}_{0} )}^{2}$$

in which, w refers to all the weights in a cluster; w₀ refers to one of the weights in the cluster; m refers to the number of weights in the cluster; and wᵢ refers to the i^{th} weight in the cluster, i is a positive integer greater than or equal to 1 and less than or equal to m, and J(w, w₀) may be referred to as a cost value. Thus, one or more cost values may be calculated respectively for the one or more weights in the cluster. A minimum cost value may be selected from the one or more cost values and the weight that corresponds to the minimum cost value may be referred to as the central weight of the cluster.

The method of determining the closest central weights of each weight in the weight group data of n layers of the neural network to the Q central weights in the preset codebook may be achieved by the following steps. Absolute values of differences between each weight and each of the Q central weights may be computed to obtain Q absolute values, wherein a central weight corresponding to a minimum absolute value of the Q central weights is the closest central weight of the weight to the Q central weights in the preset codebook.

In an alternative embodiment, the preset codebook is obtained according to the following steps: grouping a plurality of weights to obtain a plurality of groups; clustering weights in each group in the plurality of groups according to a clustering algorithm to obtain a plurality of clusters; computing a central weight of each cluster in the plurality of clusters; encoding the central weight of each cluster in the plurality of clusters and generating the codebook.

In an embodiment of the present disclosure, a plurality of weights may be grouped and then each group may be clustered to establish a codebook. The weights may be grouped in any of the following ways: putting into a group, layer-type grouping, inter-layer grouping, intra-layer grouping, mixed grouping, etc.

In an alternative embodiment, the plurality of weights may be put into a group and all the weights in the group may be clustered by K-means algorithm.

In an alternative embodiment, the plurality of weights may be grouped according to layer types. Specifically, assuming that the neural network consists of a convolution layers, b full connection layers and c long and short-term memory network layers (LSTM), a, b and c being integers, weights in each convolution layer may be put into a group, and weights in each full connection layer may be put into a group, and weights of each LSTM layer may be put into a group. In this way, the plurality of weights may be put into (a+b+c) groups and the weights in each group may be clustered by K-medoids algorithm.

In an alternative embodiment, the plurality of weights may be grouped according to the inter-layer structure. Specifically, one or a plurality of subsequent convolution layers may be put into one group, one or a plurality of subsequent full connection layers may be put into one group, and one or a plurality of subsequent LSTM layers may be put into one group. Then the weights in each group may be clustered by Clara algorithm.

In an alternative embodiment, the plurality of weights may be grouped according to the intra-layer structure. The convolution layer of the neural network may be regarded as a four-dimensional matrix (Nfin, Nfout, Kx, Ky), wherein Nfin, Nfout, Kx, and Ky may be positive integers. Nfin represents the number of input feature maps. Nfout represents the number of output feature maps. (Kx, Ky) represents the size of convolution kernels. Weights of the convolution layer may be put into Nfin*Nfout*Kx*Ky/(Bfin*Bfout*Bx*By) different groups according to the group size of (Bfin, Bfout, Bx, By), wherein Bfin is a positive integer less than or equal to Nfin, and Bfout is a positive integer less than or equal to Nfout, and Bx is a positive integer less than or equal to Kx, and By is a positive integer less than or equal to Ky. The full connection layer of the neural network may be regarded as a two-dimensional matrix (Nth, Nout), wherein Nin and Nout may be positive integers. Nin represents the number of input neurons and Nout represents the number of output neurons. The number of weights is Nin*Nout. According to the group size of (Bin, Bout), weights of the full connection layer may be put into (Nin*Nout)/(Bin*Bout) different groups, wherein Bin is a positive integer less than or equal to Nin and Bout is a positive integer less than or equal to Nout. Weights in the LSTM layer of neural network may be regarded as a plurality of combinations of weights in the full connection layer, and assuming that the weights in the LSTM layer consist of s weights in the full connection layer, s being a positive integer, each full connection layer may be grouped according to the grouping method of the full connection layer and weights in each group may be clustered by Clarans clustering algorithm.

In an alternative embodiment, the plurality of weights may be grouped in a mixed manner. For example, all the convolution layers may be put into a group; all the full connection layers may be grouped according to the intra-layer structure; all the LSTM layers may be grouped according to the inter-layer structure, and weights in each group may be clustered by Clarans clustering algorithm.

An example of the process of establishing the preset codebook is shown as follows.

Firstly, a plurality of weights may be grouped in a mixed manner to obtain a plurality of groups. FIG. 2b is a schematic diagram of a weight grouping according to an embodiment of the present disclosure. As shown in FIG. 2b, the grouped weights may be clustered and then the similar weights may be put into one cluster, thus the four clusters shown in FIG. 2c may be obtained, wherein the weights in each cluster may be marked by the same cluster identifier, and each of the four clusters may be computed according to the cost function to obtain four central weights of 1.50, −0.13, −1.3 and 0.23. Each cluster corresponds to a central weight and then the four central weights may be encoded. As shown in FIG. 2d, the cluster with the central weight being −1.3 is encoded to 00; the cluster with the central weight being −0.13 is encoded to 01; the cluster with the central weight being 0.23 is encoded to 10; and the cluster with the central weight being 1.50 is encoded to 11. The codebook shown in FIG. 2d is generated according to the four central weights and the encodings corresponding to each central weight.

An example of an establishing process of the weight dictionary is shown as follows.

Prior to quantizing the first layer weight group data, for the weight group data of n layers of the neural network shown in FIG. 2e, absolute values of differences between each weight and each central weight in the preset codebook shown in FIG. 2d may be computed. In the weight group data shown in FIG. 2e, when the weight is −1.5, the difference between the weight and the four central weights of 1.50, −0.13, −1.3 and 0.23 may be computed respectively. It can be obtained that the central weight corresponding to the minimum absolute value is −1.3, and the encoding in the codebook corresponding to the central weight (−1,3) in the codebook is 00. Similarly, the central weights corresponding to other weights may be obtained. The weight dictionary shown in FIG. 2f is generated according to the encodings of each weight in the weight group data and the encodings corresponding to the weight group data can be obtained by querying from the preset codebook as shown in FIG. 2d.

An example of the process of querying the first layer quantized weight group data corresponding to the first layer weight group data according to the weight dictionary and the preset codebook is shown as follows.

According to the weight dictionary shown in FIG. 2f, the central weight corresponding to each encoding in the weight dictionary is queried from the preset codebook shown in FIG. 2d. As shown in FIG. 2f and FIG. 2d, the central weight corresponding to the encoding 00 is −1.3, and the central weight is a quantized weight corresponding to the encoding 00. Similarly, quantized weights corresponding to other encodings may be obtained, as shown in FIG. 2g.

In an alternative embodiment, quantizing the first layer input data may include the following steps: preprocessing any element value in the first layer input data by using clip (−zone, zone) operation to obtain the first layer preprocessing data in the preset section [−zone, zone], zone being greater than 0; determining M values in the preset section [−zone, zone], wherein M is a positive integer, computing absolute values of differences between the first layer preprocessing data and the M values respectively to obtain M absolute values, and determining the minimum absolute value of the M absolute values as the quantized element value corresponding to the element value.

The preset section [−zone, zone] may be, for example, [−1,1] or [−2,2].

In an alternative embodiment, M values may be preset M values.

In an alternative embodiment, M values may be randomly generated by the system.

In an alternative embodiment, M values may be generated according to certain rules. For example, an absolute value of each value in the M values may be set to be a reciprocal of a power of 2.

In an alternative embodiment, the preprocessing operations may include at least one of the following: segmentation operations, Gauss filtering operations, binarization operations, regularization operations and normalization operations.

For example, assuming that the size of any element value of the first layer input data is quantized to 3 bits, then the value of M is not greater than 23=8. M may be set as 7 and the 7 values may be, for example, {−1, −0.67, −0.33, 0, 0.33, 0.67, 1}. If preprocessed data of an element value is 0.4, the minimum absolute value of the difference between the element value and the preprocessed data may be determined to be 0.33, then the quantized input data is 0.33.

At block 203, the processing circuit 104 determines the n^{th} layer output data gradients according to the n^{th} layer output data, obtains the n^{th} layer back operations among the n layers back operations according to the training instructions, quantizes the n^{th} layer output data gradients to obtain the n^{th} layer quantized output data gradients, queries the n^{th} layer input data gradients corresponding to the n^{th} layer quantized output data gradients and the n^{th} layer quantized input data from the preset output result table, queries the n^{th} layer weight group gradients corresponding to the n^{th} layer quantized output data gradients and the n^{th} layer quantized weight group data from the preset output result table, and updates the weight group data of n layers according to the n^{th} layer weight group gradients.

At block 204, the processing circuit 104 determines the n^{th} input data gradients as the (n-1)^{th} output data gradients and inputs the (n-1)^{th} output data gradients into the n-1 layers to execute back operations to obtain the n-1 weight group data gradients, updates the n-1 weight group data corresponding to the n-1 weight group data gradients according to the n-1 weight group data gradients. The weight group data of each layer includes at least two weights.

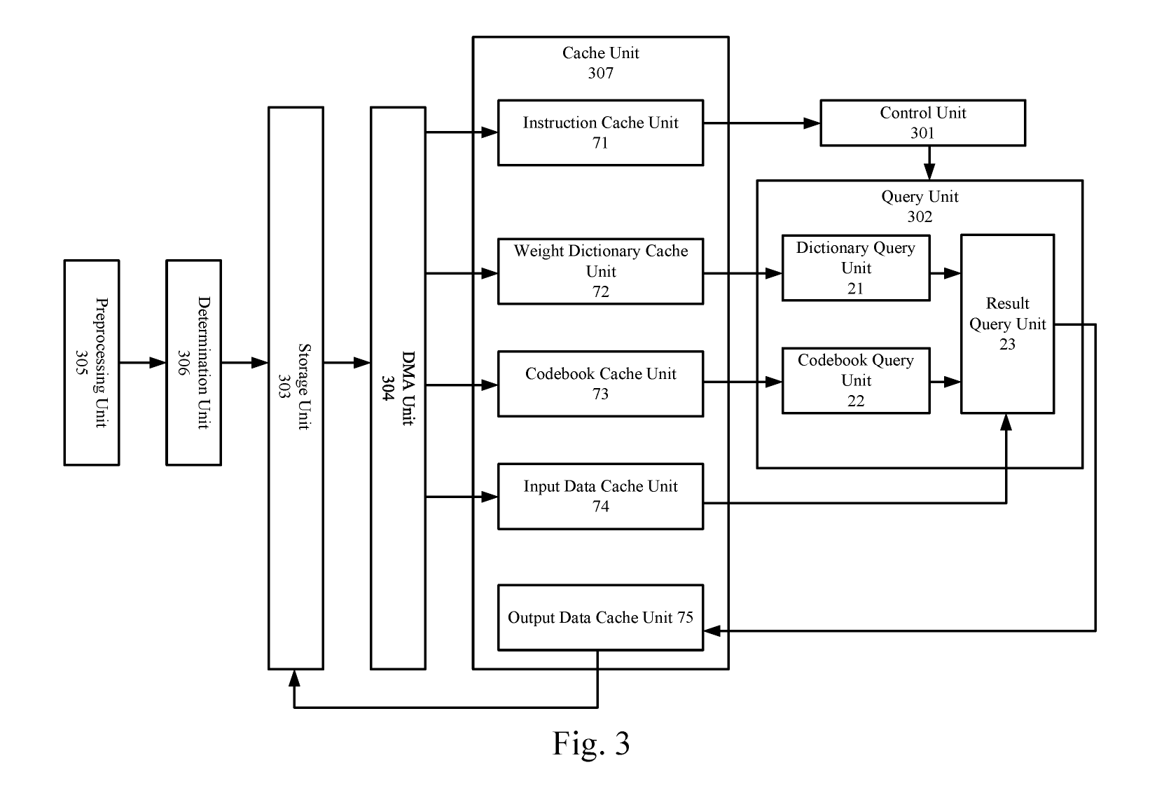

FIG. 3 is a schematic diagram of another integrated circuit chip device according to an embodiment of the present disclosure. The integrated circuit chip device includes a control unit 301, a query unit 302, a storage unit 303, a DMA unit 304, a preprocessing unit 305, a determination unit 306 and a cache unit 307, wherein,

the control unit 301 is configured to obtain quantization instructions and decode the quantization instruction to obtain the query control information, the query control information including the address information corresponding to the first layer weight group data in the preset weight dictionary, and the preset weight dictionary contains the encodings corresponding to all the weights in the weight group data of n layers of the neural network;

the query unit 302 includes a dictionary query unit 21, a codebook query unit 22 and a result query unit 23, wherein the dictionary query unit 21 is configured to query K encodings corresponding to K weights in the first layer weight group data from the preset weight dictionary according to the query control information, K being an integer greater than 1; the codebook query unit 22 is configured to query K quantized weights in the first layer quantized weight group data from the preset codebook according to the K encodings, the preset codebook including Q encodings and Q central weights corresponding to the Q encodings, Q being an integer greater than 1; the result query unit 23 is configured to query the output data corresponding to the quantized input data and the quantized weight group data from the preset output result table.

The storage unit 303 is configured to store external input data, weight dictionary, codebook, and training instructions, and also store unquantized weight group data.

The direct memory access (DMA) unit 304 is configured to directly read input data, weight dictionary, codebook and instructions from the storage unit 303, and output the input data, the weight dictionary, the codebook, and the training instructions to the cache unit 207.

The preprocessing unit 305 is configured to preprocess the first layer input data by using a clip (−zone, zone) operation to obtain the first layer preprocessing data within the preset section [−zone, zone], zone being greater than 0. The preprocessing operations include segmentation operations, Gauss filtering operations, binarization operations, regularization operations, normalization operations and the like.

The determination unit 306 is configured to determine M values in the preset section [−zone, zone], M being a positive integer, compute absolute values of differences between the first layer preprocessing data and the M values respectively to obtain M absolute values, and determine the minimum absolute value of the M absolute values as the quantized element value corresponding to the element value.

The cache unit 307 includes an instruction cache unit 71, a weight dictionary cache unit 72, a codebook cache unit 73, an input data cache unit 74 and an output data cache unit 75, wherein the instruction cache unit 71 is configured to cache training instructions; the weight dictionary cache unit 72 is configured to cache the weight dictionary; the codebook cache unit 73 is configured to cache the codebook; the input data cache unit 74 is configured to cache the input data; and the output data cache unit 75 is configured to cache the output data.

The external input data is preprocessed by the preprocessing unit 305 to obtain the preprocessed data and the quantized input data is determined by the determination unit 306. The DMA unit 304 directly reads the quantized input data, the weight dictionary, the codebook and cashes the training instructions from the storage unit 303, and then outputs and cashes the training instructions to the instruction cache unit 71, outputs and cashes the weight dictionary to the weight dictionary cache unit 72, outputs and cashes the codebook to the codebook cache unit 73, and outputs and cashes the input neuron to the input data cache unit 74. The control unit 301 decodes the received instructions, obtains and outputs query control information and operation control information. The dictionary query unit 21 and the codebook query unit 22 perform query operation on the weight dictionary and the codebook according to the received query control information to obtain quantized weight and then output the quantized weight to the result query unit 23. The result query unit 23 determines operations and operation sequence according to the received operation control information, queries the output data corresponding to the quantized input data and the quantized weight from the result query table, outputs the output data to the output data cache unit 75, and finally the output data cache unit 75 outputs the output data to the storage unit 303 for storage.

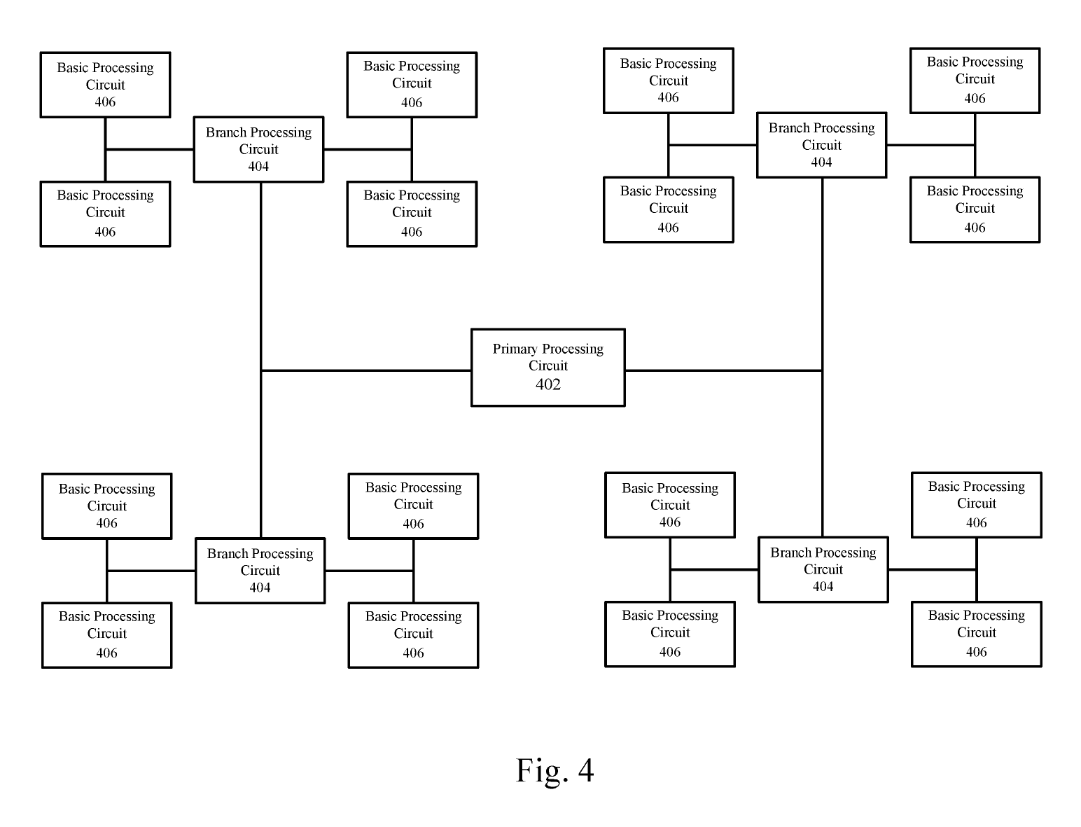

Referring to FIG. 4, FIG. 4 is a schematic diagram of a neural network chip device according to an embodiment of the present disclosure. The chip includes a primary processing circuit 402, a basic processing circuit 406 and (alternatively) a branch processing circuit 404.

The primary processing circuit 402 may include a register and/or on-chip cache circuit, and may include a control circuit, a query circuit, an input data quantization circuit, a weight group data quantization circuit and a cache circuit, wherein the query circuit includes a dictionary query unit, a codebook query unit and a result query unit. The result query unit is configured to query the output data corresponding to the quantized weight group data and the quantized input data from the preset output result table, query the input data gradients corresponding to the quantized output data gradients and the quantized input data from the preset output result table and query the weight group gradients corresponding to the quantized output data gradients and the quantized weight group data from the preset output result table. Specifically, in the n-layer neural network, corresponding vector operation output results may be queried according to operation control instructions. For example, the vector operation output results may be queried according to the vector operation instructions; corresponding logical operation output results may be queried according to logical operation instructions; and corresponding accumulation operation output results may be queried according to accumulation operation instructions.

In an alternative embodiment, the weight group data quantization circuit is specifically configured to obtain quantization instructions and decode the quantization instructions to obtain query control information, query K encodings corresponding to K weights in the first layer weight group data from the preset weight dictionary according to the query control information, and query K quantized weights in the first layer quantized weight group data from the preset codebook according to the K encodings.

In an alternative embodiment, the input data quantization circuit is configured to preprocess any element value in the input data of each layer by using clip (−zone, zone) operation to obtain the preprocessed data in the preset interval [−zone, zone], determine M values in the preset section [−zone, zone], wherein M is a positive integer, compute absolute values of differences between the first layer preprocessing data and the M values respectively to obtain M absolute values, and determine the minimum absolute value of the M absolute values as the quantized element value corresponding to the element value to quantize the input data.

In an alternative embodiment, in the process of querying results according to operation instructions by the query unit of the primary processing circuit 402, the query unit of the primary processing circuit 402 is further configured to determine the output results queried by the forward-level operation control instructions as intermediate results, and then queries output results of next-level operation instructions according to the intermediate results.

In an alternative embodiment, the primary processing circuit 402 may further include an operation circuit. Specifically, the output results queried by the forward-level operation control instruction may be configured as an intermediate result, and then the operation circuit executes operations of next-level operation control instructions according to the intermediate result.

In an alternative embodiment, the operation circuit may include a vector operational circuit, an inner product operation circuit, an accumulation operation circuit or a logical operation circuit etc.

In an alternative embodiment, the primary processing circuit 402 also includes a data transmission circuit, a data receiving circuit or interface, wherein a data distribution circuit and a data broadcasting circuit may be integrated into the data transmission circuit. In practical applications, the data distribution circuit and the data broadcasting circuit may be arranged separately; the data transmission circuit and the data receiving circuit may also be integrated to form a data transceiving circuit. Broadcast data refers to the data that needs to be transmitted to each basic processing circuit 406 and distribution data refers to the data that needs to be selectively transmitted to the part of basic processing circuits 406. The specific selection method may be determined by the primary processing circuit 402 according to the loads and computation method. The method of broadcasting transmission refers to transmitting the broadcast data to each basic processing circuit 406 in the form of broadcasting. (In practical applications, the broadcast data may be transmitted to each basic processing circuit 406 by one broadcast or a plurality of broadcasts. The number of the broadcasts is not limited in the specific implementation of the disclosure). The method of distribution transmission refers to selectively transmitting the distribution data to part of basic processing circuits 406.

The control circuit of the primary processing circuit 402 transmits data to part or all of the basic processing circuits 406 when distributing data (wherein the data may be identical or different). Specifically, if data may be transmitted by means of distribution, the data received by each basic processing circuit 406 may be different, alternatively, part of the basic processing circuits 406 may receive the same data.

Specifically, when broadcasting data, the control circuit of the primary processing circuit 402 transmits data to part or all of the basic processing circuits 406, and each basic processing circuit 406 may receive the same data.

Each basic processing circuit 406 may include a basic register and/or a basic on-chip cache circuit; alternatively, each basic processing circuit 406 may further include a control circuit, a query circuit, an input data quantization circuit, a weight group data quantization circuit and a cache circuit.

In an alternative embodiment, the chip device may also include one or more branch processing circuits 404. If a branch processing circuit 404 is included, the primary processing circuit 402 is connected with the branch processing circuit 404 and the branch processing circuit 404 is connected with the basic processing circuit 406. The inner product operation result query circuit of the basic processing circuit 406 is configured to query output results of the inner product operation from the preset result table. The control circuit of the primary processing circuit 402 controls the data receiving circuit or the data transmission circuit to transceive external data and controls the data transmission circuit to distribute external data to the branch processing circuit 404. The branch processing circuit 404 is configured to transceive data from the primary processing circuit 402 or the basic processing circuit 406. The structure shown in FIG. 4 is suitable for complex data computation because the number of units connected with the primary processing circuit 402 is limited, so a branch processing circuit 404 needs to be added between the primary processing circuit 402 and the basic processing circuit 406 to access more basic processing circuit 406, so as to realize computation of complex data blocks. The connection structure of the branch processing circuit 404 and the basic processing circuit 406 may be arbitrary and not limited to the H-type structure in FIG. 4. Alternatively, the structure from the primary processing circuit 402 to the basic processing circuit 406 is a broadcast or distribution structure, and the structure from the basic processing circuit 406 to the primary processing circuit 402 is a gather structure. Broadcast, distribution and collection may be defined as follows: distribution or broadcast structures refers to that the number of basic processing circuits 406 is greater than that of primary processing circuits 402, that is, one primary processing circuit 402 corresponds to a plurality of basic processing circuits 406, that is, the structure from a primary processing circuit 402 to a plurality of basic processing circuits 406 is a broadcast or distribution structure. On the contrary, the structure from a plurality of basic processing circuits 406 to the primary processing circuit 402 may be a gather structure.

The basic processing circuit 406 receives data distributed or broadcasted by the primary processing circuit 402 and stores the data in the on-chip cache of the basic processing circuit 406. A result query operation may be performed by the basic processing circuit 406 to obtain output results and the basic processing circuit 406 may transmit data to the primary processing circuit 402.

Referring to the structure shown in FIG. 4, the structure includes a primary processing circuit 402 and a plurality of basic processing circuits 406. The advantage of the combination is that the device may not only use the basic processing circuits 406 to perform result query operation but also use the primary processing circuit 402 to perform other arbitrary result query operations, so that the device may complete more result query operations faster under the limited hardware circuit configuration. The combination reduces the number of data transmission with the outside of the device, improves computation efficiency and reduces power consumption. In addition, the chip may arrange the input data quantization circuit and the weight group data quantization circuit in both basic processing circuits 406 and/or primary processing circuit 402, so that the input data and weight group data may be quantized in neural network computation. The chip may also dynamically distribute which circuit to perform quantization operation according to the amount of operation (load amount) of each circuit (mainly the primary processing circuit 402 and the basic processing circuit 406), which may reduce complex procedures of data computation and reduce power consumption. and dynamic distribution of data quantization may not affect the computation efficiency of the chip. The allocation method includes but is not limited to: load balancing, load minimum allocation and the like.

A neural network operation device 502 is further provided in an embodiment of the present disclosure. The device includes one or more chips shown in FIG. 4 for acquiring data to be operated and control information from other processing devices 506, performing specified neural network operations, and transmitting execution results to peripheral devices through I/O interfaces. The peripherals may include cameras, monitors, mice, keyboards, network cards, WIFI interfaces, servers, and the like. When at least one chip shown in FIG. 4 is included, the integrated circuit chip device may link and transfer data with each other through a specific structure, for example, interconnecting and transmitting data over the PCI-E bus to support larger scale neural network operations. In this case, the multiple operation devices may share the same control system or have separate control systems. Further, the multiple operation devices may share the same memory, or each accelerator may have its own memory. In addition, the interconnection method may be any interconnection topology.

The neural network operation device 502 has high compatibility and may be connected with various types of servers through the PCI-E interface.

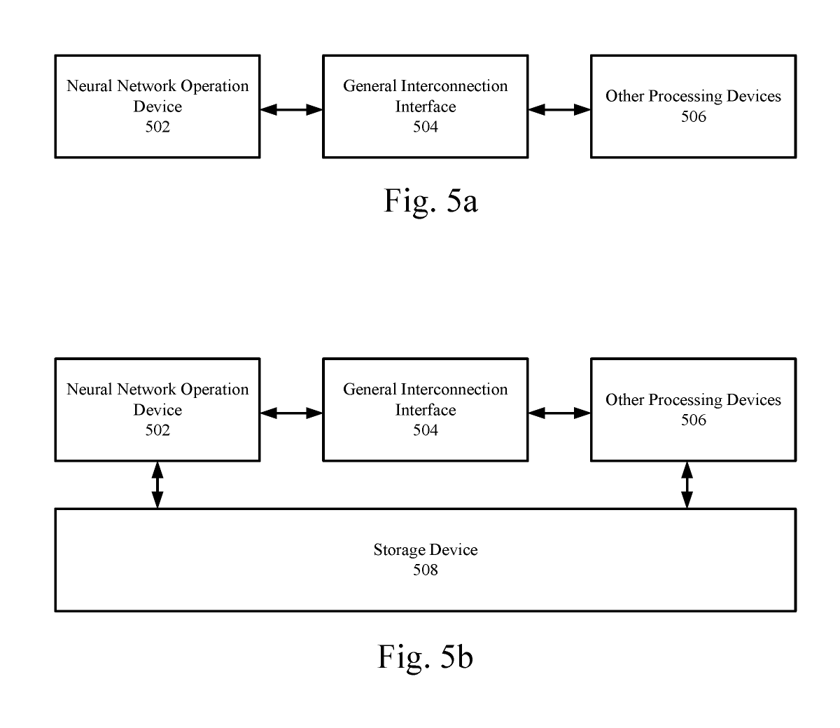

FIG. 5a is a structural diagram of a combined processing device according to an embodiment of the present disclosure. The combined processing device in the embodiment includes the neural network operation device 502, a general interconnection interface 504, and other processing devices 506 (general processing devices). The neural network operation device 502 interacts with other processing devices 506 to perform the operations specified by users.

The other processing devices 506 include at least one of general-purpose/dedicated processors such as a central processing unit (CPU), a graphics processing unit (GPU), a neural network processor and the like. The number of processors included in other processing devices 506 is not limited. The other processing devices 506 serve as an interface connecting the neural network operation device 502 with external data and control, include data moving, and perform the basic control of start and stop operations of the neural network operation device 502. The other processing devices 506 may also cooperate with the neural network operation device 502 to complete operation tasks.

The general interconnection interface 504 is configured to transmit data and control instructions between the neural network operation device 502 and the other processing devices 506. The neural network operation device 502 may obtain the input data needed from the other processing devices 506 and writes into on-chip storage devices of the neural network operation device 502. The neural network operation device 502 may obtain control instructions from the other processing devices 506 and writes into on-chip control caches of the neural network operation device 502. The neural network operation device 502 may also read data in the storage module of the neural network operation device 502 and transmit the data to the other processing devices 506.

FIG. 5b is a structure diagram of another combined processing device according to an embodiment of the present disclosure. The combined processing device further includes a storage device 508 and is configured to store the data needed in the operation unit/device or the other processing units, and is particularly suitable for storing the data which is needed to be operated and cannot be completely stored in the internal storage of the neural network operation device 502 or the other processing devices 506.

The combined processing device can be used as a SOC on-chip system of devices such as a mobile phone, a robot, a drone, a video monitoring device, etc., thereby effectively reducing the core area of control parts, increasing the processing speed, and reducing the overall power consumption. In this case, the universal interconnection interfaces of the combined processing device are coupled with certain components of the device. The components include cameras, monitors, mice, keyboards, network cards, and WIFI interfaces.

In an alternative embodiment, the disclosure provides a chip, which includes the neural network operation device 502 or the combined processing device.

In an alternative embodiment, the disclosure provides a chip package structure, which includes the chip.

In an alternative embodiment, the disclosure provides a board card, which includes the chip package structure.

In an alternative embodiment, the disclosure provides an electronic device, which includes the board card.

In an alternative embodiment, the disclosure provides an electronic device, which includes a robot, a computer, a printer, a scanner, a tablet computer, an intelligent terminal, a mobile phone, a drive recorder, a navigator, a sensor, a webcam, a cloud server, a camera, a video camera, a projector, a watch, an earphone, a mobile storage, a wearable device, a transportation means, a household electrical appliance, and/or a medical device.

Transportation means includes an airplane, a ship, and/or a vehicle. The household electrical appliance includes a television, an air conditioner, a microwave oven, a refrigerator, an electric rice cooker, a humidifier, a washing machine, an electric lamp, a gas cooker, and a range hood. The medical device includes a nuclear magnetic resonance spectrometer, a B-ultrasonic scanner, and/or an electrocardiograph.

In addition, functional units in various embodiments of the present disclosure may be integrated into one processing unit or each unit may be physically present, or two or more units may be integrated into one unit. The integrated unit may be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions making a computer device (which may be a personal computer, a server, or a network device and the like) perform all or part of the steps described in the various embodiments of the present disclosure. The memory includes various medium capable of storing program codes, such as a USB (universal serial bus) flash disk, a read-only memory (ROM), a random access memory (RAM), a removable hard disk, Disk, compact disc (CD) or the like.

Each functional unit/module in the disclosure may be hardware. For example, the hardware may be a circuit, including a digital circuit, an analog circuit and the like. The physical implementation of a hardware structure includes, but is not limited to, a physical device, and the physical device includes but is not limited to, a transistor, a memristor and the like. The computation module in the computation device may be any proper hardware processor, for example, a CPU, a graphics processing unit (GPU), a field-programmable gate array (FPGA), a digital signal processor (DSP), and an application specific integrated circuit (ASIC). The storage unit may be any proper magnetic storage medium or magneto-optical storage medium, for example, a resistance random access memory (RRAM), a DRAM, an SRAM, an embedded DRAM (EDRAM), a high bandwidth memory (HBM), and a hybrid memory cube (HMC).

Purposes, technical solutions and beneficial effects of the disclosure are further described above with the specific embodiments in detail. It should be understood that the above is only the specific embodiment of the disclosure and not intended to limit the disclosure. Any modifications, equivalent replacements, improvements and the like made within the spirit and principle of the disclosure shall fall within the scope of protection of the disclosure.

What is claimed is:

1. An integrated circuit chip device for training a neural network that includes n layers and n being an integer greater than 1, comprising:
an external interface configured to receive one or more training instructions;
a processing circuit configured to:
determine a first layer input data and a first layer weight group data,
quantize the first layer input data and the first layer weight group data to obtain a first layer quantized input data and a first layer quantized weight group data,
query a first layer output data corresponding to the first layer quantized input data and the first layer quantized weight group data from a preset output result table,
determine the first layer output data as a second layer input data, and input the second layer input data into n-1 layers to execute forward operations to obtain nth layer output data,
determine n^{th} layer output data gradients of the n^{th} layer output data,
obtain n^{th} layer back operations among the back operations of n layers of the training instructions,
quantize the n^{th} layer output data gradients to obtain n^{th} layer quantized output data gradients,
query n^{th} layer input data gradients corresponding to the n^{th} layer quantized output data gradients and a n^{th} layer quantized input data from the preset output result table,
query nth layer weight group gradients corresponding to the n^{th} layer quantized output data gradients and a n^{th} layer quantized weight group data from the preset output result table,
update a weight group data of n layers of the n^{th} layer weight group gradients,
determine the n^{th} input data gradients as (n-1)^{th} output data gradients,
input the n^{th} input data gradients into n-1 layers to execute back operations to obtain n-1 weight group data gradients, and
update n-1 weight group data corresponding to the n-1 weight group data gradients of the n-1 weight group data gradients, wherein the weight group data of each layer comprises at least two weights.

2. The device of claim 1, wherein for quantizing the first layer weight group data, the processing circuit comprises:
a control unit configured to obtain quantization instructions and decode the quantization instructions to obtain query control information,
wherein the query control information includes address information corresponding to the first layer weight group data in a preset weight dictionary, and
wherein the preset weight dictionary comprising encodings corresponding to all the weights in weight group data of n layers of the neural network;
a dictionary query unit configured to query K encodings corresponding to K weights in the first layer weight group data from the preset weight dictionary of the query control information, wherein K is an integer greater than 1; and
a codebook query unit configured to query K quantized weights in the first layer quantized weight group data from the preset codebook of the K encodings, wherein the preset codebook includes Q encodings and Q central weights corresponding to the Q encodings, and wherein Q is an integer greater than 1.

3. The device of claim 2, wherein the integrated circuit chip device further comprises a weight dictionary establishment unit configured to:
determine one or more closest central weights of each weight in the weight group data of n layers of the neural network to the Q central weights in the preset codebook prior to quantizing the first layer weight group data,
obtain the central weights corresponding to each weight in weight group data of n layers,
determine encodings of the central weights corresponding to each weight in the weight group data of n layers of the preset codebook, and
obtain the encoding corresponding to each weight in the weight group data of n layers of the neural network and generate a weight dictionary.

4. The device of claim 3, wherein the processing circuit is configured to perform one or more of the steps from a group consisting of:
grouping a plurality of weights to obtain a plurality of groups;
clustering weights in each group in the plurality of groups of a clustering algorithm to obtain a plurality of clusters;
computing a central weight of each cluster in the plurality of clusters; and
encoding the central weight of each cluster in the plurality of clusters and generating the codebook.

5. The device of claim 4, wherein the clustering algorithm comprises one or more of a group consisting of K-means algorithm, K-medoids algorithm, Clara algorithm and Clarans algorithm.

6. The device of claim 5,
wherein the neural network comprises a convolution layers, b full connection layers and c long short-term memory network layers, and
wherein the processing circuit is further configured to
group weights in each convolution layer of the plurality of weights into a group, weights in each full connection layer of the plurality of weights into a group and weights in each long short-term memory network layer of the plurality of weights into a group to obtain (a+b+c) groups, and
cluster weights in each of the (a+b+c) groups of the K-medoids algorithm.

7. The device of claim 6, wherein the processing circuit further comprises:
a preprocessing unit configured to preprocess element values in the first layer input data using a clip (−zone, zone) operation to obtain the first layer preprocessing data in the preset section [−zone, zone], zone being greater than 0; and
a determination unit configured to
determine M values in the preset section [−zone, zone], M being a positive integer,
compute absolute values of differences between the first layer preprocessing data and the M values respectively to obtain M absolute values, and
determine a minimum absolute value of the M absolute values as the quantized element value corresponding to the element value.

8. A neural network training method for executing neural network training, the neural network comprising n layers with n being an integer greater than 1, wherein the neural network training method comprises:
receiving training instructions;
determining a first layer input data and a first layer weight group data;
quantizing the first layer input data and the first layer weight group data to obtain the first layer quantized input data and the first layer quantized weight group data;
querying a first layer output data corresponding to the first layer quantized input data and the first layer quantized weight group data from the preset output result table, determining the first layer output data as the second layer input data and inputting the second layer input data into n-1 layers to execute forward operations to obtain the nth layer output data;
determining nth layer output data gradients of the nth layer output data, obtaining the nth layer back operations among back operations of n layers of the training instructions, quantizing the n^{th} layer output data gradients to obtain n^{th} layer quantized output data gradients;
querying n^{th} layer input data gradients corresponding to the n^{th} layer quantized output data gradients and a n^{th} layer quantized input data from the preset output result table, querying n^{th} layer weight group gradients corresponding to the n^{th} layer quantized output data gradients and a n^{th} layer quantized weight group data from the preset output result table, and updating the weight group data of n layers of the n^{th} layer weight group gradients;
determining the n^{th} input data gradients as the (n-1)^{th} output data gradients, inputting the (n-1)^{th} output data gradients into n-1 layers to execute back operations to obtain the n-1 weight group data gradients, updating the n-1 weight group data corresponding to the n-1 weight group data gradients of the n-1 weight group data gradients, wherein the weight group data of each layer comprises at least two weights.

9. The method of claim 8, wherein the quantizing the first layer weight group data comprises:
obtaining quantization instructions and decoding the quantization instructions to obtain query control information, the query control information comprising address information corresponding to the first layer weight group data in a preset weight dictionary and the preset weight dictionary including encodings corresponding to all the weights in the weight group data of n layers of the neural network;
querying K encodings corresponding to K weights in the first layer weight group data from the preset weight dictionary of the query control information, K being an integer greater than 1; and
querying K quantized weights in the first layer quantized weight group data from the preset codebook of the K encodings, the preset codebook including Q encodings and Q central weights corresponding to the Q encodings, and Q is an integer greater than 1.

10. The method of claim 9, wherein the preset weight dictionary is obtained according to the following steps:
determining one or more closest central weights of each weight in the weight group data of n layers of the neural network to the Q central weights in the preset codebook, prior to quantizing the first layer weight group data,
obtaining the central weights corresponding to each weight in the weight group data of n layers; and
determining encodings of the central weights corresponding to each weight in the weight group data of n layers of the preset codebook,
obtaining the encoding corresponding to each weight in the weight group data of n layers of the neural network and generating a weight dictionary.

11. The method of claim 10, wherein the preset codebook is obtained according to the following steps:
grouping a plurality of weights to obtain a plurality of groups;
clustering weights in each group in the plurality of groups of the clustering algorithm to obtain a plurality of clusters;
computing the central weight of each cluster in the plurality of clusters;
encoding the central weight of each cluster in the plurality of clusters and generating the codebook.

12. The method of claim 11, wherein the clustering algorithm comprises one or more of a group consisting of K-means algorithm, K-medoids algorithm, Clara algorithm and Clarans algorithm.

13. The method of claim 11,
wherein the neural network comprises a convolution layers, b full connection layers and c long short-term memory network layers,
wherein the grouping a plurality of weights to obtain a plurality of groups comprises grouping weights in each convolution layer of the plurality of weights into a group, weights in each full connection layer of the plurality of weights into a group and weights in each long short-term memory network layer of the plurality of weights into a group to obtain (a+b+c) groups; and
wherein the clustering weights in each group in the plurality of groups of a clustering algorithm comprises clustering weights in each of the (a+b+c) groups of the K-medoids algorithm.

14. The method of claim 13, wherein the quantizing the first layer input data comprises:
preprocessing any element value in the first layer input data using a clip (−zone, zone) operation to obtain the first layer preprocessing data in the preset section [−zone, zone], zone being greater than 0; and
determining M values in the preset section [−zone, zone], M being a positive integer,
computing absolute values of differences between the first layer preprocessing data and the M values respectively to obtain M absolute values, and
determining the minimum absolute value of the M absolute values as the quantized element value corresponding to the element value.
